(19) United States
(12) Patent Application Publication
(10) Pub. No.: US 2008/0238362 A1
(43) Pub. Date: Oct. 2, 2008

(54) Fast Battery Charger Device and Method

(75) Inventors: Leslie J. Pinnell, Framingham, MA (US); Alexander Kaplan, Providence, RI (US); Matthew R. Stone, Oxford, MA (US); Jordan T. Bourilkov, Stamford, CT (US); David C. Batson, Winchester, MA (US)

Correspondence Address: FISH & RICHARDSON P.C., P.O. BOX 1022, MINNEAPOLIS, MN, 55440-1022, US

(73) Assignee: The Gillette Company

(21) Appl. No.: 11/776,021

(22) Filed: Jul. 11, 2007

Related U.S. Application Data
(60) Provisional application No. 60/896,990, filed on Mar. 26, 2007.

(51) Int. Cl. H02J 7/00; H01M 10/44

(52) U.S. Cl. 320/107; 320/162; 320/155; 320/150

(57) ABSTRACT

Charging a rechargeable battery having one or more rechargeable cells includes determining a current level to apply to the battery such that the battery has a pre-determined charge that is reached within a specified period of time that is less than about 15 minutes and applying a charging current having substantially about the determined current level to the battery.

### CROSS-REFERENCE TO RELATED APPLICATIONS

This application claims priority to U.S. Provisional Application Ser. No. 60/896,990, entitled “Fast Battery Charger Device and Method” and filed on Mar. 26, 2007, the content of which is hereby incorporated by reference in its entirety.

### BACKGROUND

Recent developments in battery cells technology have made the idea of rapid battery charging in the range of minutes instead of hours a realistic expectation for consumers. Conventional battery and charger technologies requires at least one hour, and more typically several hours to recharge standard Li-Ion and/or NiMH battery packs and cells. For many consumer applications this recharge time often interferes with the convenience and usefulness of many devices, such as portable DVD players, digital cameras and camcorders. In the event the user has not planned ahead and made sure the device batteries were charged and ready to go, the time to recharge the batteries makes the device unavailable at the time needed.

### SUMMARY

In one aspect, a method for charging a rechargeable battery having one or more rechargeable cells includes determining a current level to apply to the battery such that the battery has a pre-determined charge that is reached within a specified period of time that is less than about 15 minutes and applying a charging current having substantially about the determined current level to the battery.

The following are embodiments within the scope of this aspect.

The method includes periodically adjusting the charging current after a pre-determined voltage level is reached to maintain the voltage between terminals of the battery at the pre-determined voltage level. The includes terminating the charging current after a period of charging time substantially equal to the specified period of time has elapsed. The pre-determined charge level of the cell is at least 90% of the charge capacity of the battery, and the specified period of time is approximately between 5-15 minutes. The method includes measuring at least one of the voltage between terminals of the battery, a temperature of the battery, and a temperature of a circuit board of a charger device configured to charge the battery, comparing the at least one of the voltage level at the terminals of the battery, the temperature of the battery, and the temperature of the circuit board to respective pre-determined ranges of voltage levels, battery temperature levels, and charger device temperature levels and terminating the charging current if any of the at least one of measured voltage level, measured temperature of the battery, and measured temperature of the circuit board lies outside the respective pre-determined ranges. Applying the charging current having the determined current level includes measuring the applied charging current and adjusting the measured applied charging current to the determined current level. The method includes causing a charger device to displace the battery from a first entry position in a charger device to a second position in the charger device such that terminals of the battery electrically couple to terminals of the charger device through which the charging current is applied. The method includes causing the charger device to displace the battery from the second position to the first entry position when the specified period of time has elapsed. Applying the charging current to the battery includes applying the charging current to a battery having at least one lithium-iron-phosphate electrochemical cell.

In an additional aspect, a charger device is configured to charge one or more rechargeable batteries each having at least one rechargeable cell. The device includes a charging compartment configured to receive the one or more rechargeable batteries, the charging compartment having terminals configured to be electrically coupled to respective terminals of the one or more rechargeable batteries and a controller configured to determine a current level to be applied to the batteries such that a pre-determined charge for the batteries is reached within a specified period of time and apply a charging current having substantially about the determined current level to the batteries.

The following are embodiments within the scope of this aspect.

The controller is further configured to periodically adjust the charging current after a pre-determined voltage level is reached to maintain the voltage between terminals of the batteries at the pre-determined voltage level. The controller is further configured to terminate the charging current after a period of charging time substantially equal to the specified period of time has elapsed. The pre-determined charge level of the batteries is at least 90% of the charge capacity of the batteries, and the specified period of time is approximately between 5-15 minutes. The device includes a first temperature sensing device configured to measure a first value indicative of the temperature of the one or more rechargeable batteries and a second temperature sensing device configured to measure a second value indicative of the temperature of a circuit board of the charger device with the controller configured to compute the temperature of the one or more rechargeable batteries based on the measured first value, compute the temperature of the circuit board based on the measured second value and determine the voltage at the terminals of the one or more rechargeable batteries. The controller is configured to compare at least one of the voltage at the respective terminals of the one or more batteries, the temperature of the one or more batteries, and the temperature of the circuit board to respective pre-determined ranges of voltage levels, battery temperature levels, and circuit board temperature levels and terminate the charging current if any of the voltage at the respective terminals of the one or more batteries, the temperature of the one or more batteries, and the temperature of the circuit board lies outside the respective pre-determined ranges. The controller configured to apply the charging current having the determined current level is configured to measure the applied charging current and adjust the measured applied charging current to the determined current level. The device includes a mechanism configured to displace the one or more batteries from an initial position on the charger device into the charging compartment. The displacement mechanism is configured to displace the one or more batteries from the charging compartment to the first entry position when the specified period of time has elapsed. The device includes the one or more batteries. The one or more batteries include one or more batteries having at least one lithium-iron-phosphate electrochemical cell. The controller includes a processor-based micro-controller.

One or more of the above aspects may include one or more of the following advantages.

The ability to charge batteries in minutes instead of hours would eliminate the need for the user to plan ahead, making the use of many portable devices not only more convenient, but also more spontaneous and more rewarding.

Other features and advantages of the invention will be apparent from the description and from the claims.

### DESCRIPTION OF THE DRAWINGS

FIG. 1 is a block diagram of an exemplary embodiment of a fast charger.

FIG. 2 is a circuit schematic of the charger of FIG. 1.

FIG. 3 is an exemplary embodiment of an AC/DC converter.

FIG. 4 is a flow diagram of an exemplary embodiment of a charger enabling procedure.

FIG. 5 is a flow diagram of an exemplary embodiment of a charging procedure.

FIG. 6 is a flow diagram of an exemplary embodiment of a post-charging procedure.

### DETAILED DESCRIPTION

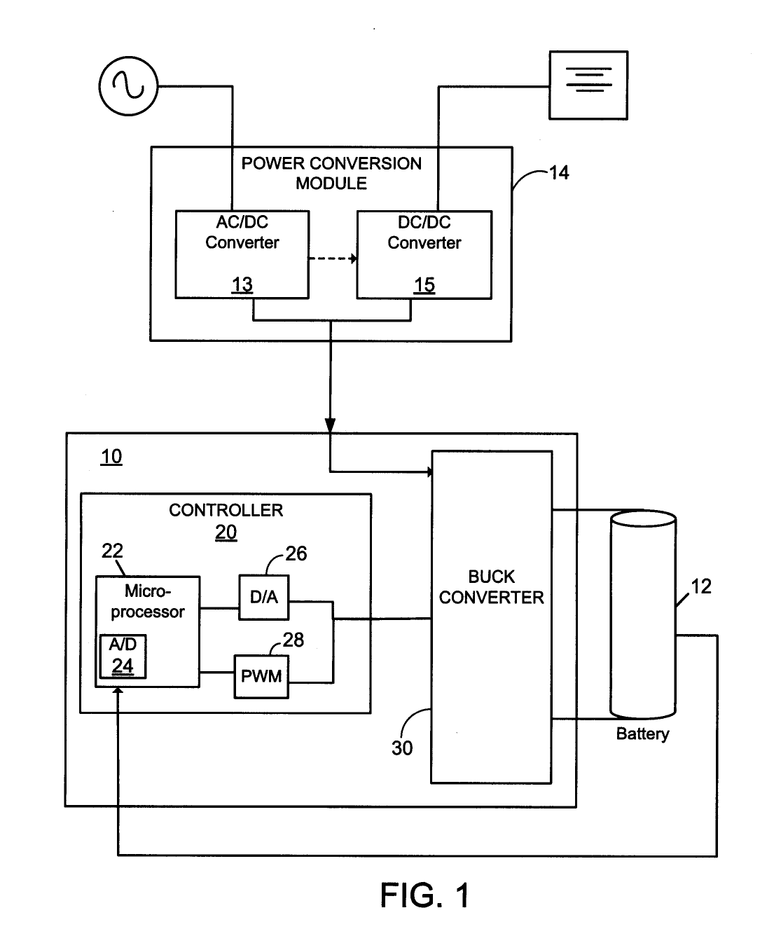

FIG. 1 shows a charger 10 configured to charge a rechargeable battery 12 that has at least one rechargeable cell. The battery 12 is received within a charging receptacle or compartment (not shown). In some embodiments, the battery 12 includes Li-Ion cells having graphitic anode material or lithium titanate anode material, and lithiated-iron-phosphate cathode materials adapted to enable fast recharge of rechargeable batteries based on such materials. The charger 10 is configured to determine a current level to be applied to the rechargeable battery 12 such that a pre-determined charge (e.g., 90% capacity) for the battery 12 is reached within a specified period of time, typically less than fifteen (15) minutes. Although FIG. 1 shows a single battery 12, the charger 10 may be adapted to receive and charge two or more rechargeable batteries at the same time.

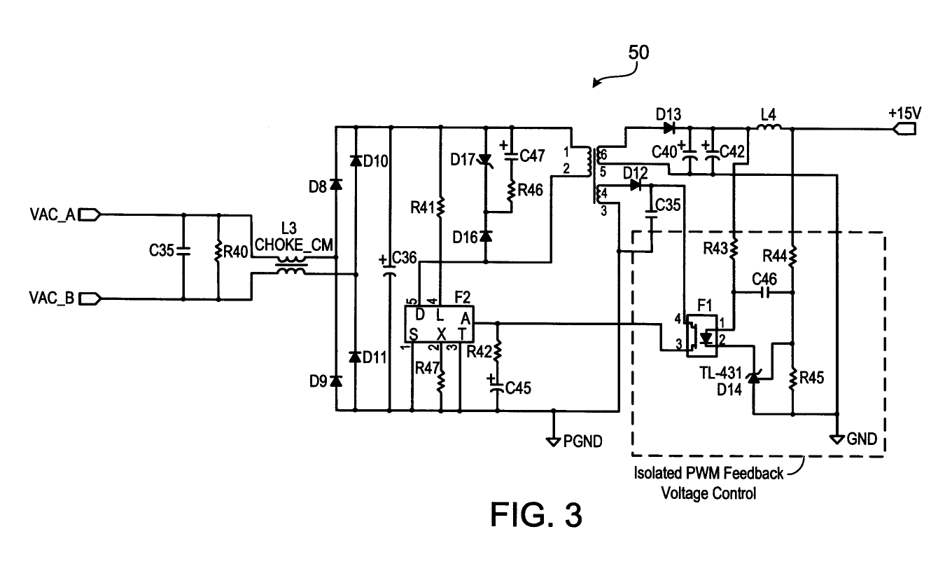

The charger 10 is coupled to a power conversion module 14. The power conversion module 14 includes an AC/DC converter 16 that is electrically coupled to an AC power source, external to the charger, such as a source providing power at a rating of 85V-265V and 50 Hz-60 Hz, and converts the AC power to a low D.C. voltage (e.g., 5-24V) and e.g., feeds this low D.C. voltage to, e.g., a DC-DC converter 20 to provide a level suitable for charging rechargeable batteries (e.g., DC voltages at levels of approximately between 3.7-4.2V for the Li-Ion cells mentioned above. Other types of cells may have different voltage levels.) The AC/DC converter 16 may be implemented as an isolated AC/DC switcher configured to accept input power at a first alternating voltage and transform it to a lower constant DC voltage. An exemplary embodiment of an AC/DC switcher 50 is shown in FIG. 3. The AC/DC converter includes a galvanic isolation between the AC input line and the DC output to prevent input AC current from reaching the DC output section of the AC/DC converter 16 and to protect the user from accidental exposure to AC current.

The AC/DC converter 16 also includes a feedback mechanism (not shown) to regulate the DC output voltage of the converter 16 so that a substantially constant voltage level is provided at the converter's output, regardless of load current drawn from the supply.

In some embodiments, an additional DC-DC converter 18 is incorporated into the power conversion module 14 to convert an external DC power source, such as a ear's DC power supply, to a DC power level suitable for charging rechargeable batteries. For example, in some embodiments, a car's DC power supply supplies approximately 11.5V to 14.3V DC power, and the DC-DC converter 18 converts that power level to a suitable power level acceptable to charge controller 20 and charge converter 30. Other power conversion configurations may also be used. The added DC-DC converter can be configured to accept almost any DC power source in the range of, e.g., 1.2V to approximately 24V, if the converter 18 is of the buck/boost configuration. If the converter is a buck type converter, then minimum DC input source should be greater than the minimum voltage required to power the charge controller and charge the battery cell, typically 5.5V or 6V.

The charger 10 determines a charging current to be applied to the rechargeable battery 12 such that the battery 12 is charged to, e.g., at least 90% charge capacity in less than 15 minutes. For example, batteries based on lithium-iron-phosphate electrochemical cells generally exhibit low internal charging resistance during the charging operation and therefore can be charged with relatively large charging currents in the order of, for example, 4 C to 15 C, where a current of 4 C is the current required to charge a rechargeable battery in 15 minutes (1 C being the current required to charge a particular rechargeable battery in 1 hour), and a current of 15 C is the current required to charge the rechargeable battery in 4 minutes. Because of the low charging resistance of lithium-iron-phosphate batteries, significant heat dissipation is avoided and accordingly such batteries can withstand high charging currents without the battery's performance or durability being adversely affected. In some embodiments, the charger 10 is configured to output 2400 mA or 12 C constant current at up to 4 V, thus allowing the charger to fully charge a high rate Li-Ion 200 mAh capacity cell (where ‘Ah’ is the unit corresponding to Amper-Hour) to greater than 90% of full capacity in, e.g., about five minutes.

The charger 10 includes a controller 20 that is configured to determine the charging current to be applied to the battery 12, apply to the battery 12 a current substantially equal to the determined charging current, and terminate the charging current after a specified or pre-determined time period has elapsed. The controller 10 may also configured to terminate the charging current once a pre-determined battery voltage or charge has been reached. In some embodiments, the charge controller 20 regulates the buck converter 30 to apply a constant 12 C charge rate until a predetermined maximum charge voltage is reached or a period of e.g., five (5) minutes has expired. Once the maximum charge voltage is reached, the charge controller 20, changes control modes and applies a constant voltage to the battery cell 12 until the pre-determined charge time has expired, e.g., 5 minutes.

Determination of the charging current to be applied to the battery 12 may be based, at least in part, on user specified input provided through a user interface (not shown) disposed on the charger 10. Such a user interface may include, for example, switches, buttons and/or knobs through which a user may indicate the type of battery that is to be recharged, the charging period, and/or other types of parameters pertaining to the charging process. To determine the specific charging current to use, a lookup table that indexes suitable charging currents corresponding to the user-specified parameters is accessed. For example, if the user specified that a lithium-iron-phosphate battery is to be recharged, and further specified a 5 minute charging period, the corresponding entry in the look-up table specifying a charging current suitable for charging the lithium-iron-phosphate battery at that time period is used. In some embodiments, computation techniques may be used to determine the appropriate charging current.

In some embodiments, determination of the charging current may be performed by identifying the battery(s) placed in the charging compartment of the charger 10 using, for example, an identification mechanism that provides data regarding characteristics of the battery 12 or by measuring characteristics of the battery that are indicative of the type of battery that is to be recharged (e.g., the battery's charging resistance.) A detailed description of an exemplary charger device that adaptively determines the charging current based on measured characteristics of the battery is provided in the concurrently filed patent application entitled “Adaptive Charger Device and Method”, the content of which is hereby incorporated by reference in its entirety.

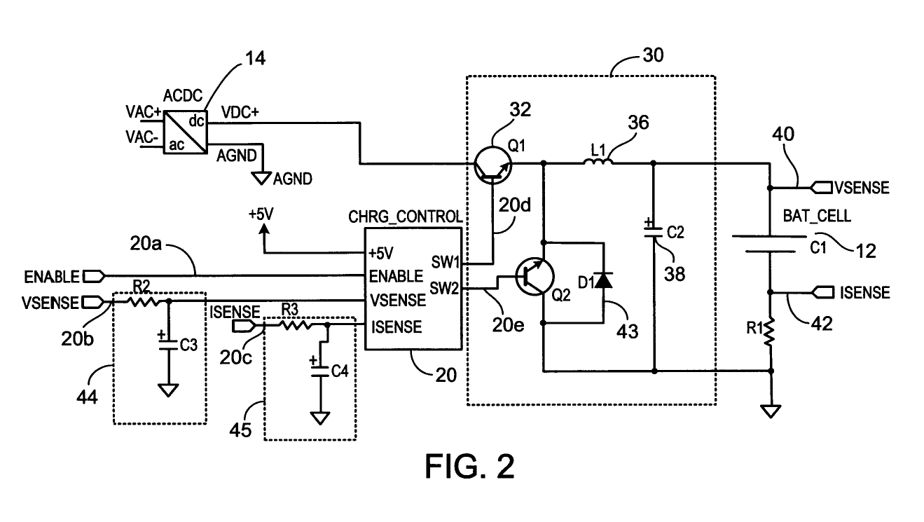

The user interface may also include an input element (e.g., switch) to enable or disable the charger 10. Upon toggling such a switch, the controller 20 receives a corresponding signal via, for example, an associated ENABLE terminal 20a (see FIG. 2). The user interface may also include output devices such as LED's to provide status information to a user regarding the charger and/or battery 12 connected thereto, a display device configured to provide output information to the user, etc. In this example, the user interface includes, e.g., a red LED that is illuminated if a fault condition, such as an over-voltage or over-temperature fault condition, occurs, and, e.g., a yellow or green LED device to indicate that the charging operation of the battery 12 is in progress.

The controller 20 includes a processor device 22 configured to control the charging operations performed on the battery 12 as will be described below. The processor device 22 may be any type of computing and/or processing device, such as a PIC18F1320 microcontroller from Microchip Technology Inc. The processor device 22 used in the implementation of the controller 10 includes volatile and/or non-volatile memory elements configured to store software containing computer instructions to enable general operations of the processor-based device, as well as implementation programs to perform charging operations on the battery 12 connected to the charger, including such charging operations that achieve at least 90% charge capacity in less than 15 minutes, and operations that detect fault conditions and prevent or stop charging operations under such circumstances.

The processor 22 includes an analog-to-digital (A/D) converter 24 with multiple analog and digital input and output lines. The A/D converter 24 is configured to receive signals from sensors (described below) coupled to the battery to facilitate regulating and controlling the charging operation. In some embodiments, the controller 20 may also include a digital signal processor (DSP) to perform some or all of the processing functions of the control device, as described herein.

The controller 20 also includes a digital-to-analog (D/A) converter device 26, and/or a pulse-width modulator (PWM), 28 that receives digital signals generated by the processor device 22 and generates in response electrical signals that regulate the duty cycle of switching circuitry, such as a buck converter 30, of the charger 10.

The controller's modules, including the processor 22, the A/D converter 24, the D/A converter 26 and/or the PWM 28, may be arranged on a circuit board (not shown) of the charger 10.

In some embodiments, the charger 10 may include an automatic load/eject mechanism (not shown) to automatically displace batteries, such as the battery 12, from a first entry position on the charger 10 to a second position within the charger's charging compartment such that the terminals of the batteries are in electrical communication with the charging terminals of the charger 10 as charging current is applied to the batteries. At the end of the charging operation the charger 10 causes the automatic load/eject mechanism to eject the batteries, thus displacing the batteries from their second position to their entry position. Such a load/eject mechanism includes a motor and a motor drive control circuit, that may be part of the controller 20, to control the load/eject operations of the mechanism, and to enable or disable the motor drive power. A load/eject mechanism provides a mechanical user interface capable of loading, charging and unloading batteries with minimal user action. A detailed description of an exemplary load/eject mechanism is provided in the concurrently filed patent application entitled “Battery Charger with Mechanism to Automatically Load and Eject Batteries”, the content of which is hereby incorporated by reference in its entirety.

FIG. 2 shows the buck converter 30 including two Bi-Polar Junction Transistors (BJT's) 32 and 34 and an inductor 36 that stores energy when the power conversion module 14 is in electrical communication with the buck converter 30, and which discharges that energy as current during periods that the power conversion module 14 is electrically isolated from the buck converter 30. The buck converter 30 shown in FIG. 2 also includes a capacitor 38 that is also used as an energy storage element. The inductor 36 and the capacitor 38 also act as output filters to reduce the switching current and voltage ripples at the output of the buck converter 30.

Power transmitted to the battery 12 from the power conversion module 14 is regulated by controlling the voltage level applied to the bases of the transistors 32 and 34. To cause power from the power conversion module 14 to be applied to the terminals of the battery 12, an actuating electric signal from terminal 20d (marked SW1) of the controller 20 is applied to the base of the transistor 32, resulting in the flow of current from the power conversion module 14 to the transistor 32 and to the battery 12. The charger 10 may also include a signal conditioning blocks, such as filters 44 and 45, for performing signal filtering and processing on analog and/or digital input signals to prevent incorrect measurements (e.g., incorrect measurements of voltages, temperatures, etc.) that may be caused by extraneous factors such as circuit level noise.

When the actuating signal applied to the base of the transistor 32 is withdrawn, current-flow from the power conversion module 14 stops and the inductor 36 supplies current from the energy stored in it. During the off-period of the transistor 32, a second actuating signal is applied by the terminal 20e (marked SW2) of the controller 20 to the base of a transistor 34 to enable current flow (using the energy that was stored in the inductor 36 and/or the capacitor 38 during the on-period of the transistor 32) through the battery 12. In some embodiments, a rectifying diode is used in place of transistor 34, the diode providing similar functionality as the transistor 34.

The transistor's on-period, or duty cycle, is initially ramped up from 0% duty cycle, while the controller or feedback loop measures the output current and voltage. Once the determined charging current is reached, the feedback control loop manages the transistor duty cycle using a closed loop linear feedback scheme, e.g., using a proportional-integral-differential, or PID, mechanism. A similar control mechanism may be used to control the transistor's duty cycle once the charger voltage output, or battery terminal voltage, reaches the crossover voltage.

Thus, the current provided by the power conversion module 14 during the on-period of the transistor 32, and the current provided by the inductor 36 and/or the capacitor 38 during the off-periods of the transistor 32 should result in an effective current substantially equal to the required charging current.

In some embodiments, controller 20 periodically receives (e.g., every 0.1 second) a measurement of the current flowing through the battery 12 as measured, for example, by a current sensor 42. Based on this received measured current, the controller 20 adjusts the duty cycle to cause an adjustment to the current flowing through the battery 12 so that that current converges to a value substantially equal to the charging current level. The buck converter 30 is thus configured to operate with an adjustable duty cycle that results in adjustable current levels being supplied to the battery 12.

As noted, the charger 10 includes sensors configured to collect data and communicate it to the controller to facilitate controlling the charging and general operations performed by the charger 10. The charger 10 includes a voltage sensor 40 (marked VSENSE) and the current sensor 42 (marked INSENSE) that are in electrical communications with the charging terminals of the charger 10 in the charging compartment. When the battery 12 is inserted into the charging compartment and the battery's terminals come in electrical contact with the charger's terminals, the sensors 40 and 42 come in electrical communication with the battery's terminals and can measure the voltage and current of the battery 12, and communicate that measured data to the controller 20.

As will be described in greater details below, based on the voltage at the terminals of the battery 12 and/or the current flowing through the battery 12, the controller determines if fault conditions exist that require that the charging operation of be terminated, or that the charging operation not be commenced. For example, the controller 20 can determine if the voltage measured by the voltage sensor 40 at the terminals of the battery 12 is within a pre-determined range of voltage levels for the battery 12 (e.g., 2 to 3.8V). If the measured value is below the lower voltage limit of the range, this may be indicative that the battery is defective. If the measured value is above the upper limit of the range, this could be indicative that the battery is already fully charged and thus further charging is not required and might damage the battery. Accordingly, if the measured voltage does not fall within the pre-determined range, a fault condition is deemed to exist.

The charger may make a similar determination with respect to the current measured via the current sensor 42, and if the measured current is outside a pre-determined current range, a fault condition would be deemed to exist, and consequently the charging operation would either not be commenced, or would be terminated.

The charger 10 further includes sensors configured to measure other attributes of either the battery 12 and/or the charger 10. For example, the charger includes temperature sensors that are configured to be coupled to the battery 12 and/or the circuit board on which the controller 20 is arranged. Suitable temperature sensors are sensors implemented using thermistors whose resistances vary according to temperature. Thus, for example, the controller 20 has a temperature sensor to measure the circuit board temperature, and determine if the measured temperature is above a certain threshold value (e.g., 60° C.) If it is, this may indicate that the charger may be overheating and a fault condition would be deemed to exist, resulting in charging operation being terminated or not being commenced.

In some embodiments, other types of remedial actions may be taken upon a determination of the existence of a fault condition. For example, in situations where the controller 20 determines that the circuit board of the charger or the battery 12 are overheating, the controller 20 may cause the charging current applied to the battery 12 to be reduced, thus causing the temperature of the battery 12 or circuit board to decrease.

In some embodiments, the received measured signals are processed using analog logic processing elements (not shown) such as dedicated charge controller devices that may include, for example, threshold comparators, to determine the level of the voltage and current level measured by the sensors 40 and/or 42. The charger 10 may also include a signal conditioning block (not shown) for performing signal filtering and processing on analog and/or digital input signals to prevent incorrect measurements (e.g., incorrect measurements of voltages, temperatures, etc.) that may be caused by extraneous factors such as circuit level noise.

The controller 20 is configured to maintain the voltage at the terminals of the battery 12 at about a substantially constant pre-determined upper voltage limit once that upper limit is reached. While the battery 12 is being charged with substantially the charging current, the voltage at terminals of the battery increases. To ensure that the voltage at the battery's terminals does not exceed the pre-determined upper voltage limit (so that the battery does not overheat, or that the battery's operation or expected life is not otherwise adversely affected), the voltage at the terminals of the battery 12 is periodically measured (e.g., every 0.1 seconds) using the voltage sensor 40 to determine when the pre-determined upper voltage limit has been reached. When the voltage at the terminals of the battery 12 has reached the pre-determined upper voltage limit, the current/voltage regulating circuit is controlled to cause a substantially constant voltage at the terminals of the battery 12 (devices that implement such a behavior are sometimes referred to as Constant Current/Constant Voltage, or CC/CV, devices)

In some embodiments, the controller 20 may also be configured to monitor the voltage increase rate by periodically measuring the voltage at the terminals of the battery 12, and adjusting the charging current applied to the battery 12 such that the pre-determined upper voltage limit is reached within some specified voltage rise period of time. Based on the measured voltage increase rate, the charging current level is adjusted to increase or decrease the charging current such that the pre-determined upper voltage limit is reached within the specified voltage rise period. Adjustment of the charging current level may be performed, for example, in accordance with a predictor-corrector technique that uses a Kalman filter. Other approaches for determining adjustments to the current to achieve the pre-determined upper voltage limit may be used.

Thus, during the constant current phase, the controller 20 controls the buck converter 30 to cause current substantially equal to the charging current level to be applied to the battery 12. When the upper voltage limit is reached, an approximate new duty cycle value is determined (for example, by using a lookup table), and the buck converter 30 is accordingly controlled. Thereafter, the controller 20, through a feedback mechanism, makes appropriate adjustments to the duty cycle of the signal that actuates the transistor 32 such that the voltage at the battery's terminals converges to substantially the constant upper voltage limit.

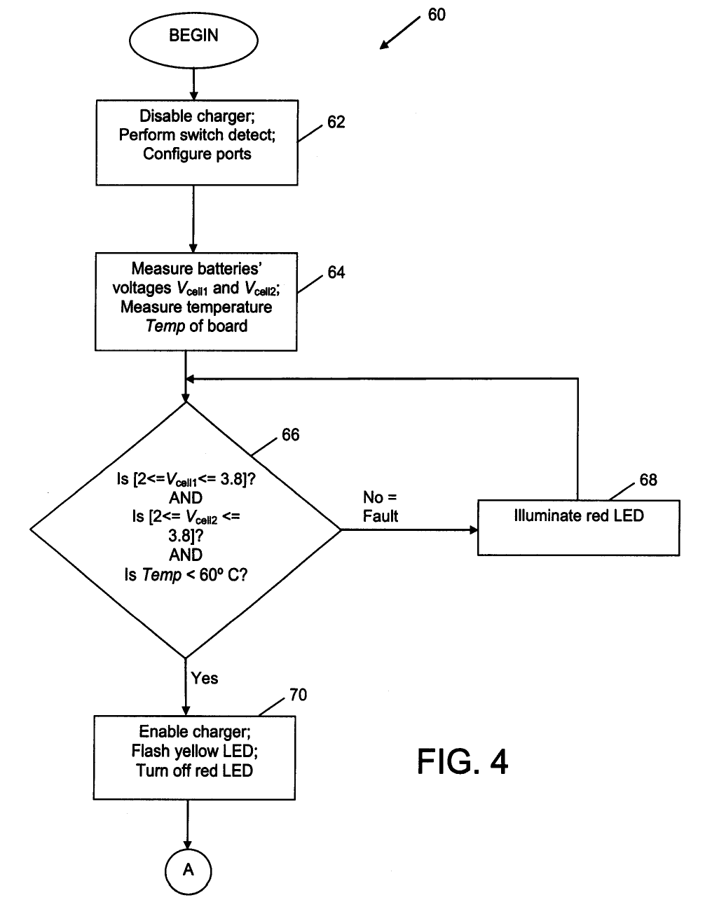

FIGS. 4-6 depict exemplary embodiments of procedures performed in the course of operation of the charger 10.

FIG. 4 depicts a charger enable procedure 60 to prepare the charger 10 for a charging operation of two batteries, such as the battery 12 shown in FIGS. 1 and 2, received within the charger's charging compartment. As shown, the charger 10 performs 62 several charger setup operations. Among the operations that are performed, the charger 10 is disabled (for example, by electrically disconnecting the output terminals 20d and 20e of the controller 20) to prevent a premature commencement of the charging operation prior to various pre-charging checks that need to be completed. Additionally, a switch detect operation is performed to determine the switch positions of the user interface disposed on the charger 10 and thus ascertain the charging profile that is desired by the user. For example, the switches of the charger user interface could indicate the desired charging period to recharge the rechargeable battery 12, the battery types of the batteries coupled to the charger, etc. Additionally, the ports of the charger 10 are configured. For example, ports that are coupled to various external sensors, such as a temperature sensor, battery voltage sensors, etc., are identified and appropriate interfacing procedure corresponding to such identified sensors (e.g., filtering, A/D conversions) may be performed.

The charger 10 measures 64 the voltages at the terminals of the batteries electrically coupled to the charger 10. In this example, two voltage measurements, V_{cell1} and V_{cell2}, corresponding to the two batteries received within the charger's charging compartment are performed. Additionally, the charger 10 measures the temperature of the board of the charger 10 to ensure that the charger is not overheating. Other measurements of the charger's and/or batteries operating conditions may be performed.

Having measured the voltages of the batteries and/or the temperature of the charger's board, the charger determines 66 if the measured values are within pre-specified ranges. Particularly, the charger 10 determines if both batteries are within an expected voltage range. For example, rechargeable batteries that have been used and had their charge depleted typically have a battery voltage of between 2-3.8V. If a battery has a voltage higher than 3.8V, this may be indicative that the battery is in fact full, and thus not only would a recharging of such a battery be unnecessary, but in fact may damage the battery. If a battery has a voltage of less than 2V, this may be indicative that the battery is damaged and thus should not be recharged. Accordingly, under circumstances in which the voltage V_{cell1} or V_{cell2} are determined to lie outside the acceptable pre-specified voltage range, the charger 10 determines that a fault condition exists.

Similarly, if the measured temperature of the board of the charger 10 is determined to be higher than some pre-specified temperature threshold, e.g., 60° C., thus indicating that the temperature of the charger 10 is too high and unsafe for use, the charger 10 determines that a fault condition exists.

In situations where a fault condition is determined to exist, the charger causes 68 a corresponding user-interface indicator to be activated. For example, the charger 10 causes a red LED disposed on the charger 10 to be illuminated, thus indicating to a user that a fault condition exists. In some embodiments, the user interface may include multiple LED's, each associated with a different cause of the fault condition, thus enabling more precise information to be provided to the user about the cause or source of the fault condition. After the red LED has been turned on, the charger may wait a certain period of time (e.g., 20 seconds) to allow the user to clear the fault. For example, if the fault condition was the result of a defective battery (e.g., if the corresponding measured voltage for that battery was less than 2V), the user can remove the battery and/or insert a working battery in its place. Under some circumstances, a fault condition may be cleared without a user-intervention (e.g., if the temperature of the charger's board is too high, the temperature may decrease without any action on the part of the user.)

The charger repeats its determination of whether a fault condition exists, until all causes of the existence of fault conditions are cleared. Once all fault conditions are cleared, the charger 10 is enabled 70, and the recharging operations can proceed. Additionally, the charger causes a corresponding user-interface indicator to be activated. For example, the charge enable operation may be indicated by causing a yellow LED to flash. Furthermore, if the red LED indicating a fault was previously turned on, that LED is turned off to indicate to a user that there are no current fault conditions.

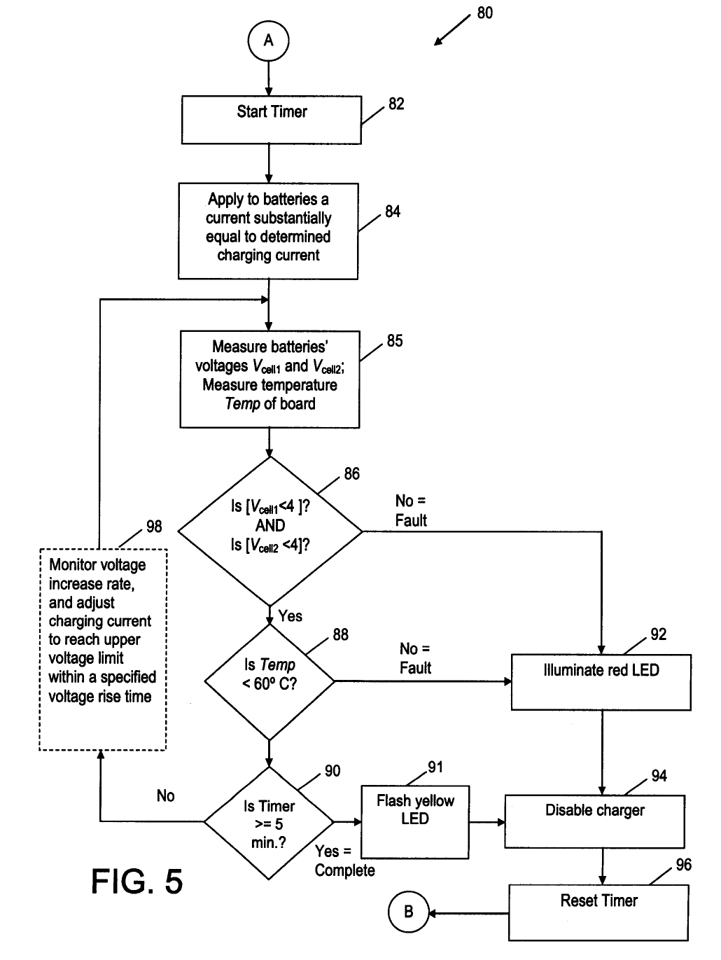

FIG. 5 depicts an exemplary embodiment of a charging procedure 80 performed by the charger 10 during the recharging of the rechargeable batteries (i.e., once the charger was enabled at 70 of FIG. 4). The charger 10 starts 82 a timer to measure the charging period during which a current substantially equal to the charging current is applied to the rechargeable batteries. The timer may be, for example, a dedicated timer module of the processor 22, or it may be a counter that is incremented at regular time intervals measured by an internal or external clock of the processor 22.

The charger 10 causes 84 the determined charging current to be applied to the batteries. As described herein, the charging current to be applied to the batteries is determined based on information specified by the user via the user interface disposed on charger 10. Such information includes the charging rate (e.g., 4 C, 15 C, etc.) or period, the battery type (in embodiments in which the charger is configured, mechanically and/or electrically, to charge multiple types of batteries), etc. This information is used to compute the charging current to be applied to the batteries using, for example, a lookup table that relates the user-provided input to corresponding charging currents, or by performing one or more computational techniques to determine the charging current. The determined charging current is used to cause electrical signals generated, for example, by the DAC or PWM, to actuate the transistors 32 and 34 of the buck converter 30.

During the charging operation, the charger 10 determines if fault conditions pertaining to the charger and/or the batteries have transpired. Thus, for example, the charger 10 determines 86 if the voltage of either of the batteries exceeds some pre-determined upper voltage limit (e,g., 4V). This determination is based on periodic measuring 85, by the charger 10, of the voltages at the terminals of the respective batteries being charged. If during the charging of the batteries the voltage at the terminals of any of the batteries exceeds that upper voltage limit, this may be indicative that the battery whose voltage exceeds the upper limit may be overheating, and thus remedial action may be required to be taken with respect to this fault condition. Accordingly, the charger 10 causes 92 the red LED indicative of the existence of a fault condition to be illuminated, and disables 94 the controller to thus terminate the charging current applied to the batteries. Also, the timer used to measure the charging period is reset 96.

Similarly, the charger also determines 88 if the temperature of the board, also periodically measured 85 by the charger 10, exceeds a pre-determined upper temperature limit (e.g., 60° C.), and if it does, the charger 10 causes 92 the red LED on the user interface to be illuminated, the charger 10 to be disabled 94, and the timer to be reset 96. The charger may determine if other types of fault conditions exist.

If there are no fault conditions, the charger determines 90 if the charging period (e.g., 5 minutes) for charging the rechargeable batteries, as may have been specified by a user through the user interface of the charger 10, has elapsed. If it the charging period has not yet elapsed, the charger 10 repeats measuring 85 the batteries' voltages and the board's temperature, determining 86 and 88 whether fault conditions exist, and determining 90 if the charging period has elapsed. The repeating of this sequence of operations may be performed after a short delay (e.g., 1-5 seconds).

When the charging period has elapsed, the charger 10 causes 91 the yellow LED to flash, disables 94 the charger 10, and resets 96 the timer. In some embodiments, the charging operation may be terminated upon the batteries reaching some pre-determined voltage level or some pre-determined charge level.

Optionally, the voltage increase rate of either of the batteries may be periodically measured to cause 98 the pre-determined upper voltage limit to be reached within the specified voltage rise period of time. Based on the measured voltage increase rate, the charging current level is adjusted (with a corresponding adjustment of the actuating signal applied to the current/voltage regulating circuit) to increase or decease the charging current such that the pre-determined upper voltage limit is reached within the specified voltage rise period. As described herein, adjustment of the charging current level may be performed in accordance to a predictor-corrector technique such as a Kalman filter or some other similar approach.

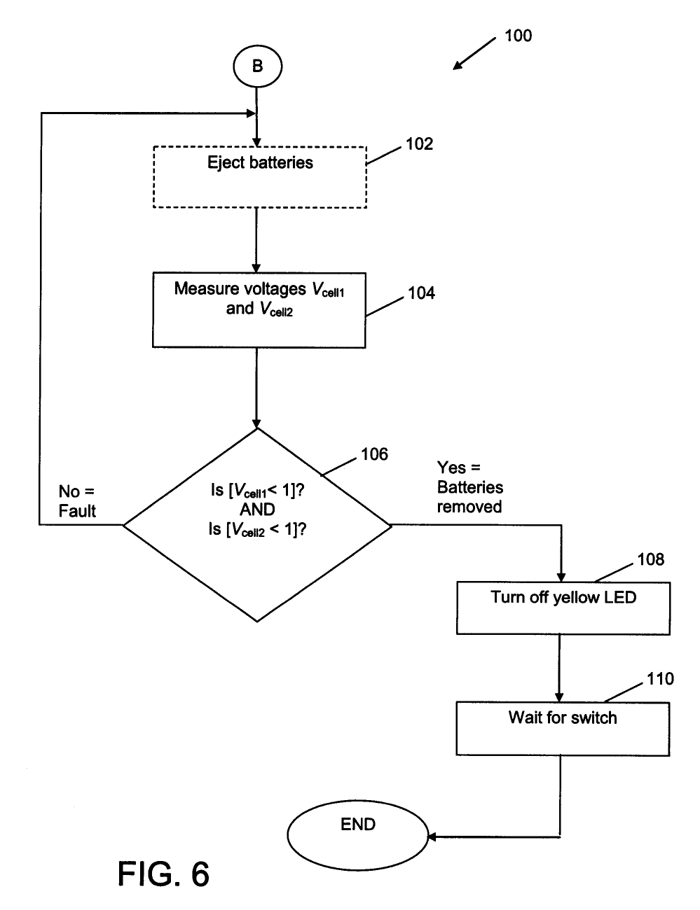

FIG. 6 depict an exemplary embodiment of a post-charging procedure 100 performed by the charger 10 after the charger 10 has been disabled, either because of the occurrence of a fault condition or because the charging operation has concluded after the charging period had elapsed, and the timer reset. In some embodiments the user manually removes the batteries from the charging compartment of the charger 10. Optionally, if the charger includes an automatic load/eject mechanism, the charger may cause 102 that mechanism to eject the batteries. Under these circumstances, the charger 10 causes the automatic load/eject mechanism to displace the batteries from their charging position to their respective entry positions.

To ensure that the batteries have been removed from the charging compartment of the charger 10, the charger's voltage sensors, such as the voltage sensor 40, measure 104 the voltage at the charger's charging terminals. If the batteries were still placed inside the charging compartment, the voltages measured would be in a range typical of the voltages at the terminals of the batteries (e.g., 2-3.8V). However, if the batteries have been removed and the charging compartments are vacant, then the voltage measured by the sensors would generally be 0. To account for any voltage leakage from the power conversion module 14, and to add some measurement tolerance, measured voltage of less than 1V at the charging terminals is deemed to indicate that the charging compartments are empty. Accordingly, the charger 10 determines 106 whether both the voltages V_{cell1} and V_{cell2} measured at the charging terminals are less than 1V. If both voltages are less than 1V, then the charger 10 turns off 108 the yellow LED on the user interface of the charger 10 to indicate that the batteries have been removed from the charging compartment. The charger 10 waits 110 for further input from the user to specify the next charging action.

If, on the other hand, one of the charging terminals voltages is equal or greater than 1V, then the charger 10 repeats measuring 104 the charging terminals voltages to determine if all the measured voltage are less than the voltage level indicative that the charging compartment is vacant. The repeating of the measuring 104 may be performed after a short delay (e.g., 1-5 seconds.)

### Other Embodiments

A number of embodiments of the invention have been described. Nevertheless, it will be understood that various modifications may be made without departing from the spirit and scope of the invention. Accordingly, other embodiments are within the scope of the following claims.

What is claimed is:

1. A method for charging a rechargeable battery having one or more rechargeable cells, the method comprising:
determining a current level to apply to the battery such that the battery has a pre-determined charge that is reached within a specified period of time that is less than about 15 minutes; and
applying a charging current having substantially about the determined current level to the battery.

2. The method of claim 1, further comprising:
periodically adjusting the charging current after a pre-determined voltage level is reached to maintain the voltage between terminals of the battery at the pre-determined voltage level.

3. The method of claim 1 further comprising:
terminating the charging current after a period of charging time substantially equal to the specified period of time has elapsed.

4. The method of claim 1, wherein the pre-determined charge level of the cell is at least 90% of the charge capacity of the battery, and wherein the specified period of time is approximately between 5-15 minutes.

5. The method of claim 1 further comprising:
measuring at least one of the voltage between terminals of the battery, a temperature of the battery, and a temperature of a circuit board of a charger device configured to charge the battery;
comparing the at least one of the voltage level at the terminals of the battery, the temperature of the battery, and the temperature of the circuit board to respective pre-determined ranges of voltage levels, battery temperature levels, and charger device temperature levels; and
terminating the charging current if any of the at least one of measured voltage level, measured temperature of the battery, and measured temperature of the circuit board lies outside the respective pre-determined ranges.

6. The method of claim 1, wherein applying the charging current having the determined current level comprises:
measuring the applied charging current; and
adjusting the measured applied charging current to the determined current level.

7. The method of claim 1, further comprising:
causing a charger device to displace the battery from a first entry position in a charger device to a second position in the charger device such that terminals of the battery electrically couple to terminals of the charger device through which the charging current is applied.

8. The method of claim 7 further comprising:
causing the charger device to displace the battery from the second position to the first entry position when the specified period of time has elapsed.

9. The method of claim 1, wherein applying the charging current to the battery comprises applying the charging current to a battery having at least one lithium-iron-phosphate electrochemical cell.

10. A charger device configured to charge one or more rechargeable batteries each having at least one rechargeable cell, the device comprising:
a charging compartment configured to receive the one or more rechargeable batteries, the charging compartment having terminals configured to be electrically coupled to respective terminals of the one or more rechargeable batteries; and
a controller configured to:
determine a current level to be applied to the batteries such that a pre-determined charge for the batteries is reached within a specified period of time; and
apply a charging current having substantially about the determined current level to the batteries.

11. The device of claim 10, wherein the controller is further configured to:
periodically adjust the charging current after a pre-determined voltage level is reached to maintain the voltage between terminals of the batteries at the pre-determined voltage level.

12. The device of claim 10, wherein the controller is further configured to:
terminate the charging current after a period of charging time substantially equal to the specified period of time has elapsed.

13. The device of claim 10, wherein the pre-determined charge level of the batteries is at least 90% of the charge capacity of the batteries, and wherein the specified period of time is approximately between 5-15 minutes.

14. The device of claim 10 further comprising:
a first temperature sensing device configured to measure a first value indicative of the temperature of the one or more rechargeable batteries; and
a second temperature sensing device configured to measure a second value indicative of the temperature of a circuit board of the charger device;
and wherein the controller is further configured to:
compute the temperature of the one or more rechargeable batteries based on the measured first value;
compute the temperature of the circuit board based on the measured second value; and
determine the voltage at the terminals of the one or more rechargeable batteries.

15. The device of claim 14, wherein the controller is further configured to:
compare at least one of the voltage at the respective terminals of the one or more batteries, the temperature of the one or more batteries, and the temperature of the circuit board to respective pre-determined ranges of voltage levels, battery temperature levels, and circuit board temperature levels; and
terminate the charging current if any of the voltage at the respective terminals of the one or more batteries, the temperature of the one or more batteries, and the temperature of the circuit board lies outside the respective pre-determined ranges.

16. The device of claim 10, wherein the controller configured to apply the charging current having the determined current level is configured to:
measure the applied charging current; and
adjust the measured applied charging current to the determined current level.

17. The device of claim 10, further comprising:
a mechanism configured to displace the one or more batteries from an initial position on the charger device into the charging compartment.

18. The device of claim 17, wherein the displacement mechanism is further configured to:
displace the one or more batteries from the charging compartment to the first entry position when the specified period of time has elapsed.

19. The device of claim 10 further comprising the one or more batteries.

20. The device of claim 19, wherein the one or more batteries include one or more batteries having at least one lithium-iron-phosphate electrochemical cell.

21. The device of claim 10, wherein the controller includes a processor-based micro-controller.
